(19) United States
(12) Patent Application Publication
(10) Pub. No.: US 2012/0050876 A1
(43) Pub. Date: Mar. 1, 2012

(54) DIHEDRAL CORNER REFLECTOR ARRAY OPTICAL ELEMENT AND METHOD FOR FABRICATING THE SAME AND DISPLAY DEVICE USING THE SAME

(75) Inventors: Takashi SUGIYAMA, Tokyo (JP); Yuki Kitamura, Tokyo (JP); Yasuhiro Aoki, Tokyo (JP)

(73) Assignee: STANLEY ELECTRIC CO., LTD., Tokyo (JP)

(21) Appl. No.: 13/212,363

(22) Filed: Aug. 18, 2011

(30) Foreign Application Priority Data
Aug. 30, 2010 (JP) 2010-191744
Nov. 29, 2010 (JP) 2010-264820

(51) Int. Cl. G02B 27/10; B29D 11/00

(52) U.S. Cl. 359/625; 264/1.1

(57) ABSTRACT

For a method fabricating a dihedral corner reflector array optical element, a molding die having a reversal shape of the prism bodies is used. Each prism body has a frustum shape having an end plane whose area is smaller than that of the base plane side of the substrate. Each prism body is composed of a rectangular parallelepiped portion including the orthogonal plane sides to be a dihedral corner reflector and a taper portion integrated therewith having sides being non-parallel to the orthogonal plane sides. The method includes clamping the molding die to define a cavity therein; forming the optical element made from molten resin in the cavity; and parting the optical element from the molding die. The molding dies are relatively moved in a parting direction that the molding die leaves the orthogonal plane sides before anything else to part the optical element.

### BACKGROUND OF THE INVENTION

1. Field of the Invention

The present invention relates to a refractive real specular image forming element forming a real image (real specular image) of an observed object in a space of a viewer side, and more particularly to a dihedral corner reflector array optical element and a method for fabricating the same and a display device using the same.

2. Description of the Related Art

There have been suggested a display device for allowing a viewer to see a real image (real specular image) of an observed object in air (see WO2007-116639).

Specifically, such a display device comprises a refractive real specular image forming element performing the formation of a real image (real specular image) of an observed object in a space of a viewer side; and the observed object disposed in a space opposite to the viewer side with respect to the refractive real specular image forming element.

The document WO2007-116639 discloses a refractive real specular image forming element (so-called the dihedral corner reflector array optical element) in which a plurality of unit optical elements (each so-called as dihedral corner reflector) are arranged regularly on one plane of the element face wherein each of unit optical elements has two orthogonal mirror surface which are perpendicular to each other. The dihedral corner reflector array optical element disclosed by WO2007-116639 specifically utilizes inner walls of a square shaped hole made in a substrate while penetrating the element face as a dihedral corner reflector. Further as shown in FIG. 1, there is also disclosed a dihedral corner reflector array optical element comprising a plurality of transparent cube shape tubular bodes 5 each perpendicularly protruding in the thickness direction (Z) from the surface of the substrate 60 (XY plane) made of a transparent material from wherein inner wall surfaces (mirror surfaces 61a and 61b) of a transparent cube shape tubular body 5 are used for the dihedral corner reflector 61, wherein the tubular bodies are laid out in a grid pattern.

In a plurality of the arranged dihedral corner reflector of the dihedral corner reflector array optical element, since each mirror surface is disposed perpendicularly to the element face, light (emitted from the observed object existing on the one side of the element face) is reflected twice by the dihedral corner reflector during passing theretrough, and then by all light passed through the element, a real image is formed in a space of observed object absent on the other side of the element face. Namely, the dihedral corner reflector array optical element performs the formation of real image in such a manner that the real image of the object exists symmetrical to the observed object with respect to the element face (so-called a plane of symmetry) of the dihedral corner reflector array optical element

The resin injection molding may be utilized for a method for fabricating the dihedral corner reflector array optical element including the cube tubular body the inner walls of which is used for the dihedral corner reflector in the prior art. In such an injection molding, there is used a stamper (molding die) having a reversal shape of a plurality of cube tubular bodies as shown in FIG. 1, and then a molten resin is injected into a cavity of the molding die, and then the molded dihedral corner reflector array optical element is parted from the molding die. However, since the optical element bite a plurality of tubular bodies, it is very difficult to remove the molded optical element from the stamper. For example, there is the optical element affixes on the stamper. In addition, when the optical element is forcedly peeled off the stamper, then the peeled stamper becomes the distorted dihedral corner reflector array optical element causing distortion or bokeh of real image for the image formation of the optical element, in a serious case, no formation of real image occurs (not observed) as a problem.

### SUMMARY OF THE INVENTION

Accordingly, there are tasks to be achieved by the present invention to provide a dihedral corner reflector array optical element comprising a substrate and a plurality of prism bodies arranged regularly on and each protruding from a base plane of the substrate wherein the prism bodies and the substrate are integrally formed of a transparent material, each prism body including two orthogonal plane sides which are perpendicular to each other to be a dihedral corner reflector, wherein when an observed object exists by one surface side of the substrate then the dihedral corner reflector array optical element forms a clear real image of the object by the other surface side of the substrate, while forming a transparent material a real image, and particular to provide a method for fabricating the dihedral corner reflector array optical element in a facilitated manner to remove it from molding dies, and a display device using the optical element.

The inventors have aimed at how to bring it about a precision molding for the dihedral shape, and made earnest efforts to fabricate the dihedral corner reflector array optical element including side walls (inner walls) of the protruding prism body from the substrate as a dihedral corner reflector while using the injection molding of transparent resin such as acrylic resin or the like. As a result, it has been found that surface precision of the dihedral corner reflector and shape precision of a vertex (crest edge) of the prism body formed between the dihedral and top face (end plane) influence the performance of the formation of real image. Due to the injection molding, in case that the dihedral corner reflector array optical element has an insufficient sharpness of a vertex shape of the prism body caused by a poor transferability, the inventors have found that the dihedral corner reflector array optical element gives distortion or bokeh in a real image, in a serious case, no formation of real image occurs (not observed). The inventors have overcome such a problem and made up the present invention. The present invention is made in main view of improvement of transferability to a suitable shape for the prism body in an injection molding to settle round of a vertex shape (poor sharpness) of each prism body of the dihedral corner reflector array optical element and pretend the fallen performance of in the formation of real image.

A method according to the present invention is a method for fabricating a dihedral corner reflector array optical element which comprises a substrate and a plurality of prism bodies arranged regularly on and each protruding from a base plane of the substrate wherein the prism bodies and the substrate are integrally formed of a transparent material, each prism body including two orthogonal plane sides which are perpendicular to each other to be a dihedral corner reflector, wherein when an observed object exists by one surface side of the substrate then the dihedral corner reflector array optical element forms a real image of the object by the other surface side of the substrate, the method comprising:

clamping a first molding die and a second molding die to define a cavity therebetween, where the first molding die has a reversal shape of the prism bodies and the second molding die has a flat face, where each prism body has a frustum shape having an end plane whose area is smaller than that of the base plane side of the substrate, where each prism body is composed of a rectangular parallelepiped portion including the orthogonal plane sides and a taper portion integrated therewith having sides being non-parallel to the orthogonal plane sides;

forming a dihedral corner reflector array optical element made from molten resin in the cavity; and

parting the dihedral corner reflector array optical element from the molding dies after cooled.

The addition of a tapered structure, or inclination (i.e., “draft angle”) to the prism body allows removing the dihedral corner reflector array optical element the prism body from a stamper (molding die). The incline direction of the tapered structure is a direction that an area of the end plane the prism body is smaller than that of the bottom plane (the base plane) on the substrate side.

The foregoing problem is solved by the method for fabricating the optical element further comprising a step of injecting the molten resin into the cavity while keeping the molding die at a temperature of higher than a predetermined temperature; and cooling the molding die at another temperature less than the predetermined temperature after the cavity filled. In case fabricating the optical element by this method, there is obtained an improved transferability of the dihedral corner reflector array optical element. The predetermined temperature is a softening temperature of the resin used in the forming step. It is preferable to provide respectively metal reflective films on the orthogonal plane sides of the prism body functioning as dihedral corner reflectors in the dihedral corner reflector array optical element fabricated by the foregoing injection molding. The reflectance of the dihedral corner reflector is improved thereby.

It is the most important matter to make shapes the orthogonal plane sides of the dihedral corner reflector with a high shape accuracy and a high planar (specularity) for the cube shape prism body shown in FIG. 1 and the tapered prism body.

Since the two sides of the dihedral corner reflector are perpendicular to the substrate, when the injection molded dihedral corner reflector array optical element is removed commonly from the molding die (stamper) in a perpendicular direction to the substrate, the two sides of the dihedral corner reflector are moved and scratched on the stamper, so that there is a scratch on the two sides of the dihedral corner reflector, resulting in the problem that the bokeh of a real image (real specular image) of the observed object occurs due to a distorted performance of the formation of real image, which discovery inspires to device the present invention.

In the foregoing method fabricating a dihedral corner reflector array optical element according to the present invention, there is provided a molding die has a reversal shape of the prism bodies, where each prism body has a frustum shape having an end plane whose area is smaller than that of the base plane side of the substrate, where each prism body is composed of a rectangular parallelepiped portion including the orthogonal plane sides to be a dihedral corner reflector and a taper portion integrated therewith having sides being non-parallel to the orthogonal plane sides. Thus, the method according to the present invention comprises a step of clamping the molding die to define a cavity therein; a step of forming a dihedral corner reflector array optical element made from molten resin in the cavity; and a step of parting the dihedral corner reflector array optical element from the molding die wherein the molding dies are relatively moved in a parting direction that the molding die leaves the orthogonal plane sides before anything else to part the dihedral corner reflector array optical element after cooled.

The frustum shape of the prism body may be a truncated pyramid wherein the taper portion is formed as a non-parallel plane side for example.

In addition, it is preferable that the parting direction is set within a pyramid-like space extent surrounded by two orthogonal side virtual planes and two taper virtual planes and having a vertex of the end plane and the orthogonal plane sides of the prism body, wherein the orthogonal side virtual planes are extended parallel to the orthogonal plane sides respectively and the taper virtual plane are parallel to the sides being non-parallel to the dihedral corner reflector respectively, wherein the parting direction is astray direction extended from the vertex in the end plane of the prism body and inclined away from a line of intersection of the orthogonal plane sides. If each prism body has a truncated pyramid shape for example, the parting direction with respect the normal line of substrate is set to a direction of a half angle of an angle made between a intersection line of the taper portion' planes being non-parallel and a intersection line of the orthogonal plane sides.

The taper portion' taper angle (i.e., angle with respect the normal line of substrate) is set to be a large value in tacking into account of parting of the optical element form the stamper. When the taper portion' taper angle value is too large, the end plane's area of the prism body decreases. Thus since the end plane of the prism body have a functions a light exit surface of light reflected by the dihedral corner reflector, a real image (real specular image) of the observed object is darken. Further, even if the area of the end plane is secured for a light real image imaged, when the area of the bottom plane of the prism body increases, then there decreases the number of the dihedral corner reflector per a unit area of the optical element, so that likewise a real image (real specular image) of the observed object is darken.

With respect to such contrary situations, according to our experimentations of injection molding using various taper angles for the prism body, it has been found that the foregoing taper angle (i.e., an angle formed between a taper face and a plane perpendicular to the substrate) being an angle within range of 5° or more and 25° or less is suitable.

When the prism body has a right rectangular frustum shape, there are two plane sides other than the two sides of the dihedral corner reflector (expect the end plane and the bottom plane), such two plane sides are formed to have the foregoing inclination. Such two plane sides may be formed to have the same taper angle, alternatively to have different taper angles. Provided that the molding die is fabricated by a reversal method such as the electro-forming process, when two plane sides are formed to have the same taper angle, only one kind of a tool bit is required for fabrication. This is convenient.

Further, an optical element according to the present invention is a dihedral corner reflector array optical element, fabricated by the method according to claim 1, comprises:

a substrate; and

a plurality of prism bodies arranged regularly on and each protruding from a base plane of the substrate,

wherein the prism bodies and the substrate are integrally formed of a transparent material, each prism body including two orthogonal plane sides which are perpendicular to each other to be a dihedral corner reflector, wherein when an observed object exists by one surface side of the substrate then the dihedral corner reflector array optical element forms a real image of the object by the other surface side of the substrate, wherein the prism bodies and the second molding die has a flat face, where each prism body has a frustum shape having an end plane whose area is smaller than that of the base plane side of the substrate, where each prism body is composed of a rectangular parallelepiped portion including the orthogonal plane sides and a taper portion integrated therewith having sides being non-parallel to the orthogonal plane sides.

Still further, there is realized a display device using the dihedral corner reflector array optical element fabricated by the method according to claim 1 comprising: an observed object disposed by one surface side of the substrate, wherein the dihedral corner reflector array optical element forms a real image of the object by the other surface side of the substrate.

According to the invention of the dihedral corner reflector array optical element, there are formed two plane sides other than the two sides of the dihedral corner reflector, such two plane sides are formed to have the foregoing inclination, and therefore frictional resistance between the stamper (molding die) and the dihedral corner reflector array optical element is reduced, thereby it is easy to part the dihedral corner reflector array optical element from the stamper. In addition, according to the invention, there are prevented reduced scratch damages of the dihedral corner reflector of mirror surfaces during a parting step, so that a clear real image of the object is observed by the dihedral corner reflector array optical element. In addition, as secondary advantageous effect, the present invention provides the reduction of passing light to the observer due to multiple reflections with the prism body with truncated pyramid shape.

### BRIEF DESCRIPTION OF THE DRAWINGS

The aforementioned aspects and other features of the present invention are explained in the following description, taken in connection with the accompanying drawing figures wherein:

FIG. 1 is an enlarged partial cutaway perspective view illustrating a conventional dihedral corner reflector array optical element having cube shape tubular bodies;

FIG. 2 shows an enlarged partial cutaway perspective view illustrating the dihedral corner reflector array optical element having protruding prism bodies of the embodiment according to the present invention;

FIG. 3A and FIG. 3B are cross-section views taken off at an A-A line and a B-B line in FIG. 2 respectively;

FIG. 4 is an enlarged perspective view illustrating a prism body of the dihedral corner reflector array optical element of the embodiment according to the present invention;

FIG. 5 is a schematic cross section view illustrating a tool bit of diamond used in manufacture of a stamper used in the method for fabricating a dihedral corner reflector array optical element of the embodiment according to the present invention;

FIG. 6 is an enlarged partial schematic cross section view illustrating a copper master plate after the machining process;

FIG. 7 is an enlarged partial schematic cross section view illustrating a stamper obtained through an electro-forming process;

FIGS. 8A through 8E are partial schematic cross section views illustrating molding dies to explain an injection molding process for fabricating a dihedral corner reflector array optical element of an example according to the present invention;

FIG. 9 is a schematic cross section view illustrating a molding die under control of temperature in case of the injection molding method for fabricating a dihedral corner reflector array optical element of an embodiment according to the present invention;

FIGS. 10 through 12 are schematic cross section views each illustrating a molding die in case of the injection molding method for fabricating a dihedral corner reflector array optical element of another embodiment according to the present invention;

FIGS. 13A through 13E are partial schematic cross section views illustrating molding dies to explain an injection molding process for fabricating a dihedral corner reflector array optical element of another example according to the present invention;

FIG. 14A is a cross section view of a prism body of a dihedral corner reflector array optical element according to the present invention to explain schematically the prism body, and FIG. 14B is a top view of the prism body and FIG. 14C is a perspective view of the prism body;

FIGS. 15A through 15E are partial schematic cross section views illustrating molding dies to explain an injection molding process for fabricating a dihedral corner reflector array optical element of further another example according to the present invention;

FIGS. 16A through 16E are partial schematic cross section views illustrating molding dies to explain an injection molding process for fabricating a dihedral corner reflector array optical element of still further another example according to the present invention;

FIG. 17 is a schematic cross section view illustrating a molding die to explain a control of temperature thereof in case of an injection molding process for fabricating a dihedral corner reflector array optical element of further another example according to the present invention;

FIG. 18 and FIG. 19 are partial schematic cross section views illustrating molding dies in case of an injection molding process for fabricating a dihedral corner reflector array optical element of another example according to the present invention;

FIG. 20A and FIG. 20B are enlarged photograph images each partially showing a front view of a dihedral corner reflector array optical element fabricated by an example method according to the present invention;

FIG. 21A through 21E are partial schematic cross section views illustrating molding dies to explain a comparative injection molding process for fabricating a dihedral corner reflector array optical element;

FIG. 22A and FIG. 22B are enlarged photograph images each partially showing a front view of a dihedral corner reflector array optical element fabricated by the comparative method;

FIG. 23A is a partial cutaway plan view illustrating a specific example of a dihedral corner reflector array optical element applied to the display device of the embodiment according to the present invention;

FIG. 23B is an enlarged partial cutaway perspective view illustrating the dihedral corner reflector array optical element applied to the display device of the embodiment;

FIG. 24 is a schematic perspective view illustrating how a real image is formed by a dihedral corner reflector array applied to the embodiment according to the invention;

FIG. 25 is a schematic plan view illustrating how a real image is formed by the dihedral corner reflector array optical element applied to the display device of the embodiment according to the invention; and

FIG. 26 is a schematic side view illustrating how a real image is formed by the dihedral corner reflector array optical element applied to the display device of the embodiment according to the invention.

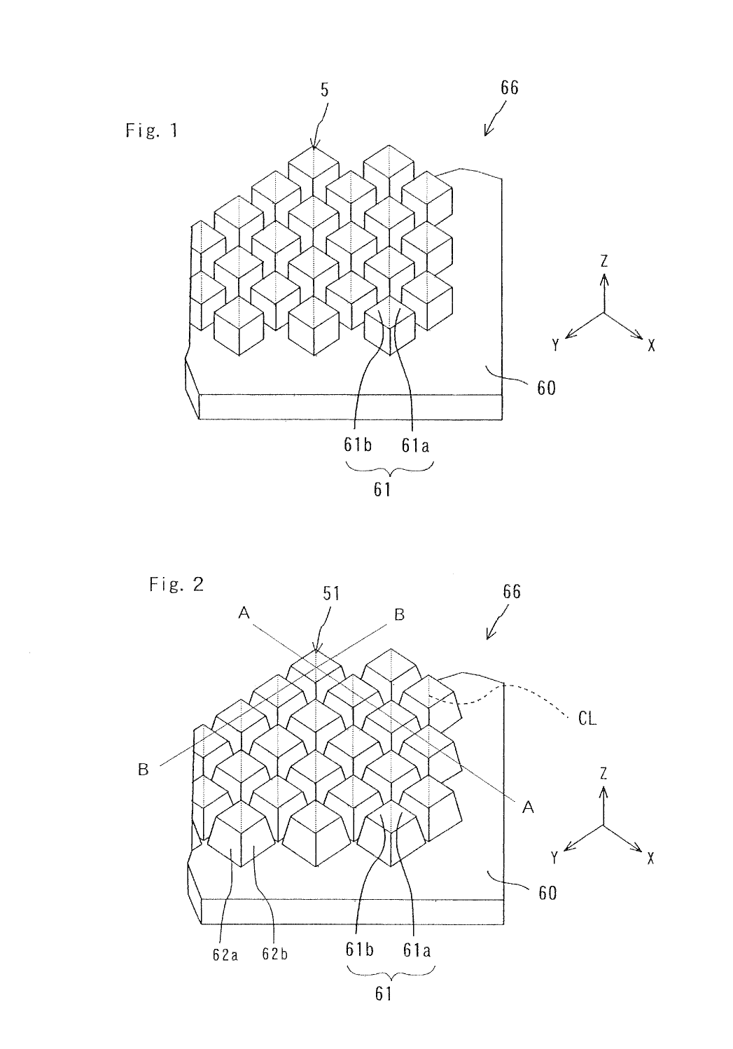

### DETAILED DESCRIPTION OF THE INVENTION

A dihedral corner reflector array optical element and a method for fabricating the same and a display device using the same of embodiments according to the present invention will be described herein below by referring to the drawings.

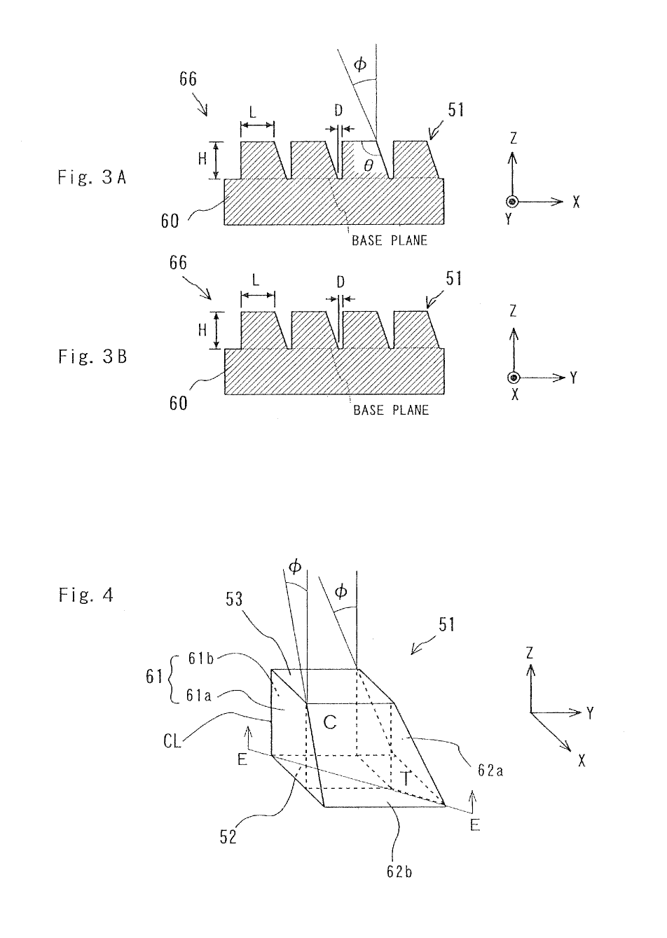

FIG. 2 shows an enlarged partial cutaway perspective view illustrating the dihedral corner reflector array optical element 66 having protruding prism bodies 51 of the embodiment according to the present invention. Further, FIG. 3A and FIG. 3B are cross-section views taken off at an A-A line and a B-B line in FIG. 2 respectively.

The dihedral corner reflector array optical element 66 of the example comprises a substrate 60 of a flat board and a plurality of prism bodies 51 which are integrally formed of a transparent material transparent material wherein prism bodies protrude from a base plane of the substrate. On each prism body, two orthogonal plane sides (mirror surfaces 61a and 61b) are formed to be perpendicular to each other to be a dihedral corner reflector 61 at a line of intersection CL thereof. Plane sides 62a and 62b (other than two mirror surfaces of the dihedral corner reflector) of the prism body have some bearings (inclination) with respect to a normal line of the substrate 60. FIG. 3 shows the measure of the prism body 51, a height H, a side length of the end plane L, an interval D, and an angle θ (i.e., inclination angle with respect to the end plane), for one example, the height H=170 μm, the side length of a square L=150 μm, the interval D=10 μm, the inclination angle θ=108° (φ=18°) as typical values, but the measure of the prism body is not by these values.

As shown in FIG. 4, the sides 62a and 62b being non-parallel to the dihedral corner reflector belong to taper portions of a prism body with a truncated pyramid shape 51 which has an area of the end plane 53 smaller than that of the base plane 52 (the bottom plane) of the substrate side. The sides 62a and 62b being non-parallel to the dihedral corner reflector are taper faces. It is preferable to set a taper angle of each taper face (i.e., an angle formed between the taper face and a plane perpendicular to the substrate) to be an angle within range of 5° or more and 25° or less is suitable. When the taper angle is less than 5°, then the parting of dies is difficult. When the taper angle is more than 25°, then the prism body density decreases thereby to reduce luminous flux for the formation of real image.

As shown in FIG. 4, the prism body 5 has the truncated pyramid shape which is composed of a rectangular parallelepiped portion C (e.g., a cube) including the orthogonal plane sides 61a and 61b and a taper portion T having plane sides 62a and 62b being non-parallel to the orthogonal plane sides wherein the rectangular parallelepiped portion C and the taper portion T are integrated.

Specifically, there is described an example of an injection molding method for fabricating a dihedral corner reflector array optical element comprising the substrate and the prism body.

A stamper (molding die) is previously formed to have a reversal shape corresponding to an array plurality of prism bodies each having a truncated pyramid shape as shown in FIG. 2.

There is described briefly the machining process using a tool bit of diamond and the electro-forming process to form a predetermined stamper with a reversal shape as follows.

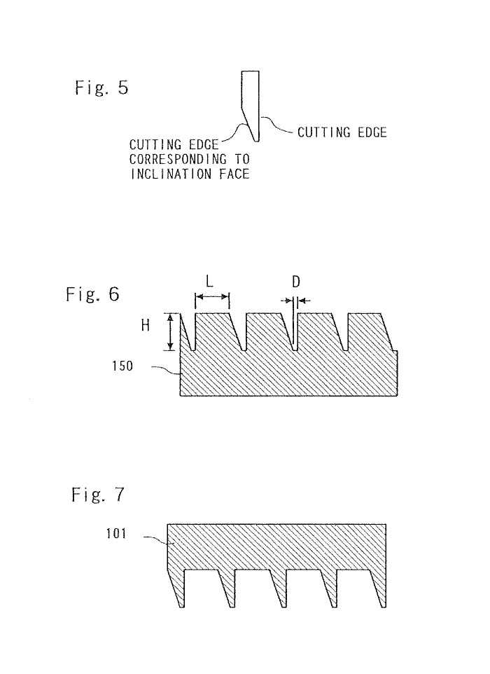

First, in a preparatory step, a tool bit of diamond (blade for cutting) is provided which has a one side of vertical cutting edge face and the other side of cutting edge face corresponding to the inclination face of the prism body, as shown in FIG. 5.

Then, for example, a copper master plate (not shown) of a square place having a predetermined thickness is provided. Through the machining process, using the tool bit of diamond of FIG. 5, the copper master plate is machined to have a reversal shape corresponding to the dihedral corner reflector array optical element. Specifically, parallel grooves are cut with a predetermined pitch parallel to one side of square of the copper master plate sequentially. Then, vertical grooves are cut with the predetermined pitch parallel to the preceding cut grooves sequentially. For the cutting of the optical element having the cross-section shown in FIG. 3, the repetition of digging for one groove to a 5 μm depth per one stroke is preformed up to the sum 170 μm depth, and then the tool bit of diamond is shifted to a next line position at the predetermined pitch, and then those steps are repeated. After the machining process, there is obtained a mockup of the dihedral corner reflector array optical element of the copper master plate 150 with a plurality of protruding prism bodies 51. FIG. 6 shows a schematic enlarged partial cross section view illustrating such the copper master plate 150.

Then, after the machining process, the electro-forming process of nickel plating is performed using the copper master plate, so that nickel stamper 101 of the molding die having a reversal shape of the copper master plate with the prism bodies being the same as the dihedral corner reflector array optical element. FIG. 7 shows a schematic enlarged partial cross section view illustrating the resulted stamper 101 from the electro-forming process.

### EXAMPLE 1

There is described as Example 1 in which, in order to improve the transferability of a molding operation, a molten resin is injected into a cavity of the molding die while the stamper (first molding die) is kept at a temperature of higher than a predetermined temperature, and then the molding die is cooled at another temperature less than the predetermined temperature after the cavity filled resin, so that a formed dihedral corner reflector array optical element is parted from the first second molding dies.

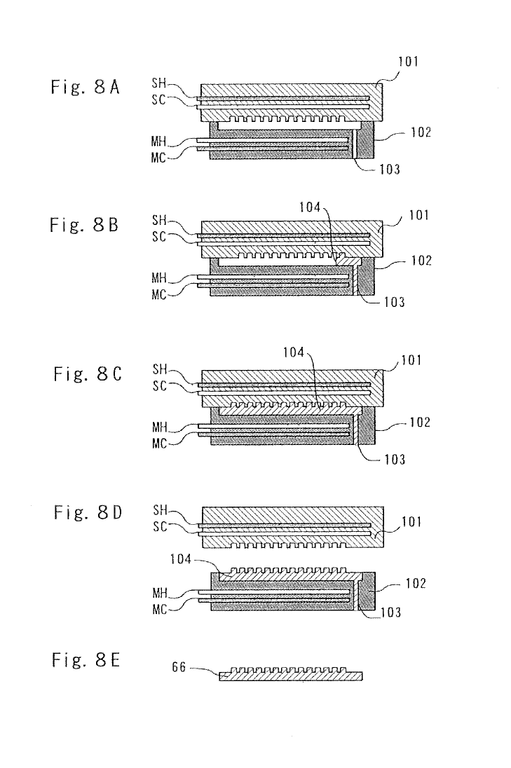

First, as shown in FIG. 8A, the predetermined stamper 101 and the second molding die 102 having a flat face are clamped to be contact directly with each other, and kept the molding dies at a temperature of higher than a softening temperature of a resin (for example 200° C., since a softening temperature of acrylic resin is about 100° C.) by heating it. There are embedded in the stamper 101 used in the example both of a heating device SH to heat the stamper and a cooling device SC to cool the stamper. There are also embedded in the second molding die 102 used in the example both of a heating device MH to heat the molding die and a cooling device MC to cool the molding die. The cooling devices SC, MC are connected through water pipes to circulating apparatuses of a water cooling type respectively, and the heating devices SH, MH are resistance heaters for example.

Then, as shown in FIG. 8B, a molten resin 104 is injected through a molding die gate portion 103 into a cavity between the stamper 101 and the second molding die 102 with a high pressure. At this time, the stamper 101 and the second molding die 102 are kept at 120° C. temperature (higher than a softening temperature of acrylic resin) by the heating devices. The maintaining of temperature is performed under the control of the heating devices SH, MH and the cooling devices SC, MC.

Then, as shown in FIG. 8C, after injection of the resin 104, the stamper 101 and the second molding die 102 directly contacted with each other are cooled to a temperature lower than the softening temperature of the resin 104 (for example 80° C. for acrylic resin). Such control of cooling is also performed under the control of the heating devices SH, MH and the cooling devices SC, MC.

Then, as shown in FIG. 8D, the second molding die 102 and the stamper 101 are parted from each other. At this time, it is preferable that the molded dihedral corner reflector array optical element together with the second molding die 102 can be parted from the stamper 101.

Then, as shown in FIG. 8E, the molded dihedral corner reflector array optical element 66 is removed from the second molding die 102. Since the dihedral corner reflector array optical element has the flat face on the molding die side, such removing is easily done comparatively. This is because the “draft angle”, one of features of this example, is useful for the prism body with truncated pyramid shape. When resin portions remaining in the gate portion are cut from the molded then the dihedral corner reflector array optical element completed. During the parting step, the maintaining of controlled temperature is performed under the control of the heating devices SH, MH and the cooling devices SC, MC.

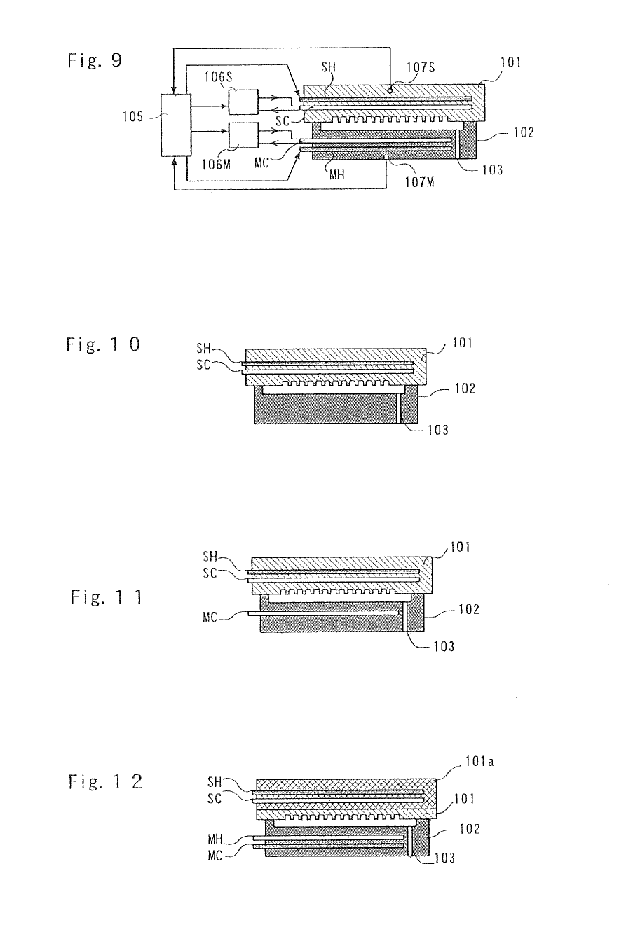

FIG. 9 refers to the description of the control of temperature of the stamper 101 and the second molding die 102 using the heating devices SH, MH and the cooling devices SC, MC.

The heating device SH, MH of the stamper 101 and the second molding die 102 are connected to the control unit 105 for performing the on-off control of the heating devices.

The cooling devices SC, MC of the stamper 101 and the second molding die 102 are connected through water pipes to circulating apparatuses 106S, 106M of water cooling type respectively. The circulating apparatuses 106S, 106M are connected to the control unit 10 for performing the flow control of water in the circulating apparatuses.

Temperature sensors 107S, 107M such as the thermo-couple are provided in the stamper 101 and the second molding die 102 at suitable sites respectively. The temperature sensors 107S, 107M detect temperatures of the stamper 101 and the second molding die 102 respectively.

Either when the stamper 101 and the second molding die 102 are preliminarily heated by the heating device SH, MH or when the resin 104 is injected into the cavity of the stamper 101 and the second molding die 102, then temperature rises. The temperature is detected by the temperature sensors 107S, 107M attached to the stamper 101 and the second molding die 102, and then the output signal of the temperature sensors is received by the control unit 105 and then when the control unit judges a temperature higher than the predetermined temperature, the control unit 105 give commands to make the circulating apparatus 106S, 106M increase the amount of coolant of water from zero towards a pertinent value of the allowed upper flow in the circulating apparatus 106S, 106M so that a descent of temperature can be controlled. The temperature of the stamper 101 and the second molding die 102 decreases as the ascent of water flow. The decrease of temperature is detected by the temperature sensors 107S, 107M attached to the molding dies, and then the output signal of the temperature sensors is received by the control unit 105 and then when the control unit judges a temperature lower than the predetermined temperature, the control unit 105 give commands to make the circulating apparatus 106S, 106M decreases the amount of coolant of water from the allowed flow towards zero in the circulating apparatus 106S, 106M so that a ascent of temperature can be controlled. The temperature of the stamper 101 and the second molding die 102 increases as the descent of water flow. As described above, the control unit 105 performs and controls the temperature of the stamper 101 and the second molding die 102.

Although the heating device and the cooling device are provide in the stamper 101 and the second molding die 102 respectively (see FIG. 8, FIG. 9) in the above examples, there are other examples such that the heating device SH and the cooling device SC are provided only in the stamper 101 (see FIG. 10), and that the stamper 101 accommodates the heating device SH and the cooling device SC at the same time, the cooling device MC is provided only in the second molding die 102 (see FIG. 11), or the like and the variation thereof is possible. As a result of experiences, it have been found that there is preferable that at least the cooling device is provided in the stamper 101 and the second molding die 102 as shown in FIG. 9 and FIG. 11.

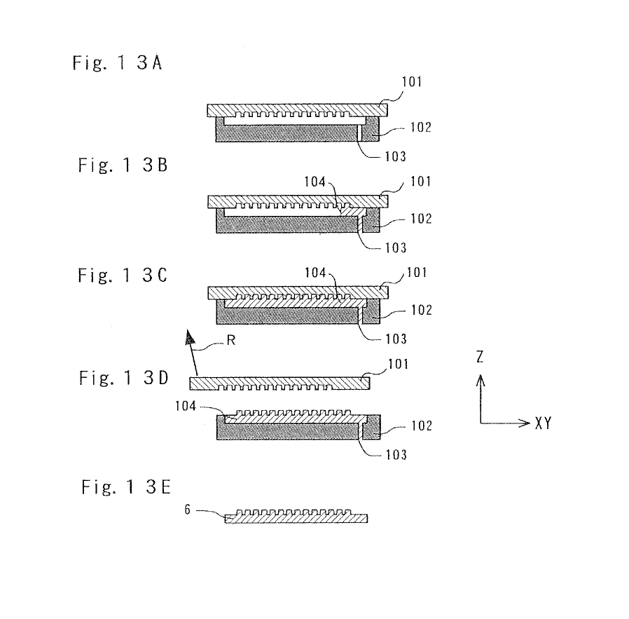

Further, in case that the stamper 101 has a thickness insufficient to built-in of the heating device or the cooling device, an auxiliary metal die 101a may be provided to be contact directly to the stamper 101 so that the heating device SH and the cooling device SC are built-in the auxiliary metal die 101a (see FIG. 12).

### EXAMPLE 2

There is described as Example 2 in which, in order to improve the mold releasability, the molding apparatus is operated so that at least of one of the second molding die 102 and the stamper 101 is moved relatively in the parting direction R, and then a formed dihedral corner reflector array optical element is parted from the first second molding dies.

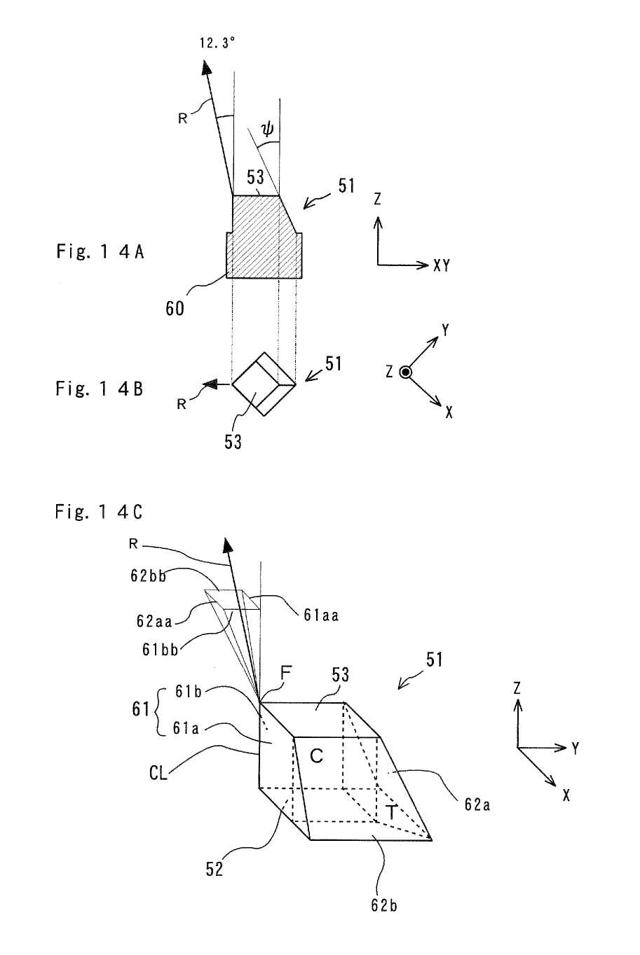

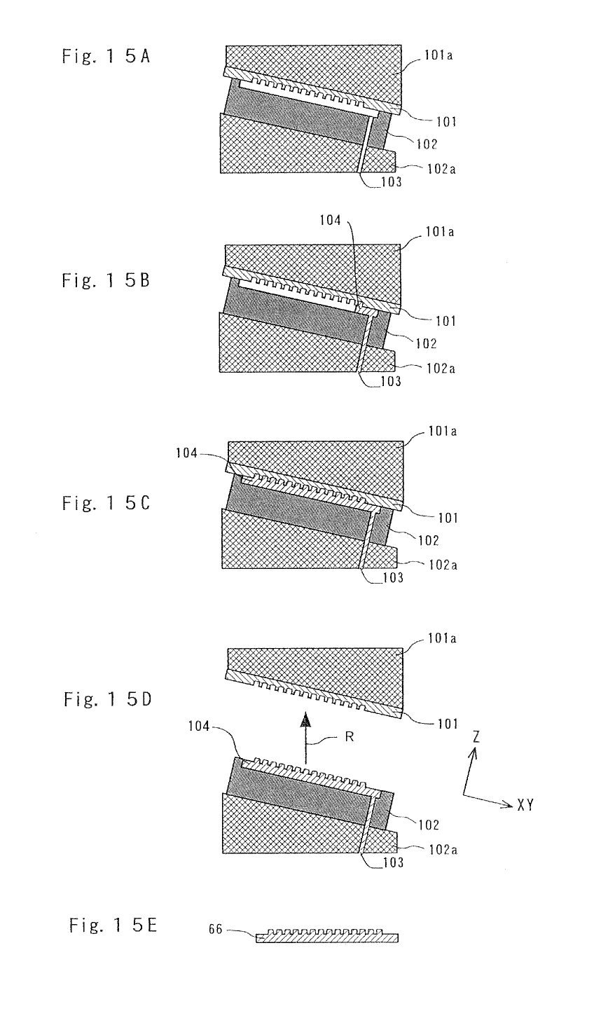

First, as shown in FIG. 13A, the predetermined stamper 101 and the second molding die 102 having a flat face are clamped to be contact directly with each other, and then theses are heated up to a temperature of higher than a softening temperature of a resin to be injected (for example 200° C. for use of acrylic resin).

Then, as shown in FIG. 13B, a molten resin 104 is injected through a molding die gate portion 103 into a cavity between the stamper 101 and the second molding die 102 with a high pressure.

Then, as shown in FIG. 13C, after injection of the resin 104, the stamper 101 and the second molding die 102 directly contacted with each other are cooled to a temperature lower than the softening temperature of the resin 104 (for example 80° C. for acrylic resin).

Then, as shown in FIG. 13D, the second molding die 102 and the stamper 101 are parted from each other while the stamper 101 moves in a straight line direction R inclined from a normal line of the substrate i.e., parting direction R that the stamper 101 leaves the dihedral corner reflector (the plane sides 61a and 61b shown in FIG. 4) before anything else. At this time, it is preferable that the molded dihedral corner reflector array optical element together with the second molding die 102 can be parted from the stamper 101.

Then, as shown in FIG. 8E, the molded dihedral corner reflector array optical element 66 is removed from the second molding die 102. Since the dihedral corner reflector array optical element has the flat face on the molding die side, such removing is easily done comparatively. When resin portions remaining in the gate portion are cut from the molded then the dihedral corner reflector array optical element completed.

In this example, the inclined straight line direction (the parting direction R) has been set to be at an angle of 12.3° with respect to a normal line of the substrate. Such a set angle is obtained with a calculation on the basis of sizes and angles shown in FIG. 3, for example. Since each of sides 62a and 62b (taper faces) is inclined at the inclination angle φ=18° to a normal line of the substrate, a line of intersection of sides 62a and 62b (taper faces) is inclined at φ=24.6° to a normal line of the substrate. Therefore, as shown in FIG. 14, the parting direction R is set to be at an angle of 12.3° i.e., half of the angle φ. Besides, FIGS. 14 show diagrams to explain schematically the parting direction R of the stamper with respect to the prism body of the dihedral corner reflector array optical element in the example; FIG. 14A shows a cross section view of a prism body taken off at line E-E shown in FIG. 4; FIG. 14B is a top view of the prism body; and FIG. 14C is a perspective view of the prism body.

As shown in FIG. 14C, the parting direction R of the example is a stray direction extended from a crest point F (vertex) in the end plane 53 of the prism body 51 and inclined away from a line of intersection CL of the orthogonal mirror surfaces 61a, 61b (i.e., a normal line of the substrate). Thus, the parting direction R is set within a pyramid-like space extent surrounded by two orthogonal side virtual planes 61aa, 61bb and two taper virtual planes 62aa, 62bb and having a vertex F of the end plane 53 and the orthogonal plane sides 61a, 61b of the prism body (i.e., the crest point F), wherein the orthogonal side virtual planes 61aa, 61bb are extended parallel to the orthogonal plane sides 61a, 61b respectively and the taper virtual plane 62aa, 62bb are parallel to the sides 62a, 62b being non-parallel to the dihedral corner reflector respectively.

### EXAMPLE 3

Regarding the manner shown in FIG. 13, there may be a problem that the relative movement of the second molding die 102 or the stamper 101 in the foregoing parting direction R is difficult on account of the molding apparatus. Commonly dies or stampers are allowed to move in the direction perpendicular to the reference surface of the molding apparatus. To such a problem, we provide a solution that the stamper and die are configured so as to be inclined with a predetermined angle to the reference surface. For the purpose of inclined settings of the stamper and die with the predetermined angle, a metal block part 102a and an auxiliary metal die 101a are provided to incline and fix the second molding die 102 and the stamper 101 at the predetermined angle to the reference surface of the molding apparatus. Specially, the metal block part 102a and the auxiliary metal die 101a are metallic blocks each having complementary flat surfaces inclined at a predetermined angle (12.3°) with respect to the reference surface of the molding apparatus. Besides, although this embodiment employs individual auxiliary metal block parts, the stampers or dies can be integrally fabricated to include necessary parts corresponding to those parts as one piece.

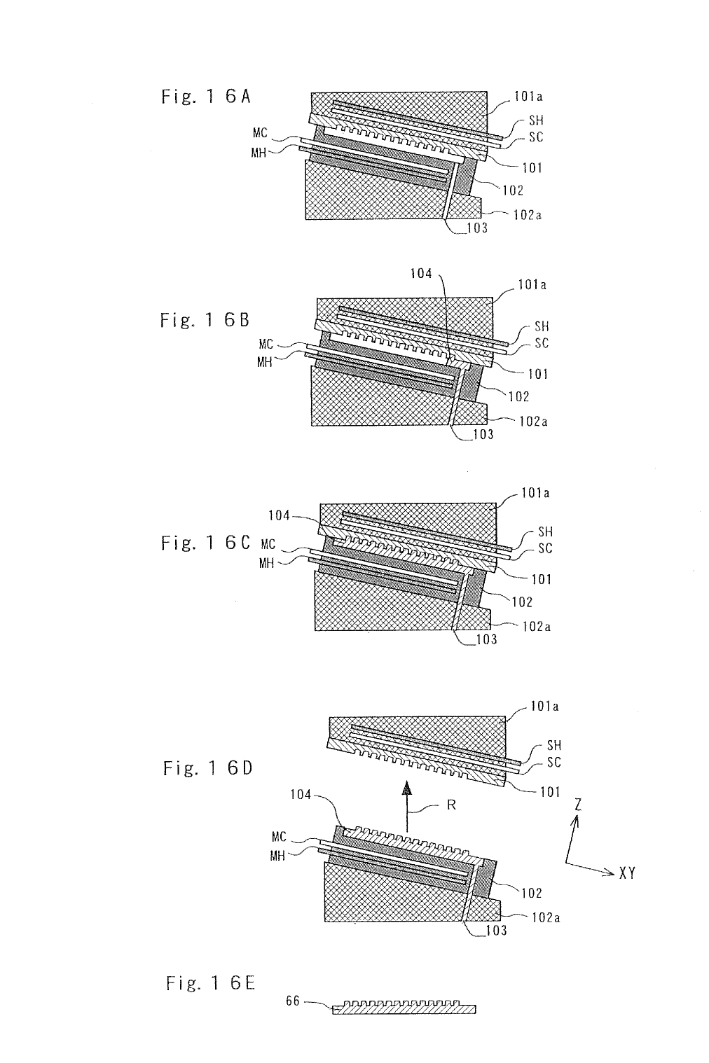

The injection molding process as shown in FIG. 15A through FIG. 15E is the same as that of the foregoing approach shown in FIG. 13A though FIG. 13E except that the metal block part 102a and the auxiliary metal die 101a are provided. Therefore the detail for FIG. 15A through FIG. 15E is omitted.

As shown in FIG. 15D, the second molding die 102 and the stamper 101 are parted to each other while moving in the moving direction (the parting direction R) in the molding apparatus. The metal block part 102a and the auxiliary metal die 101a exist and the second molding die 102 and the stamper 101 are inclined with the predetermined angle. Therefore, for the molded optical element, such a configuration is the same as the dies are parted from each other while diagonally moving in a straight line direction R inclined with the line of intersection of the two taper portions.

### EXAMPLE 4

In addition, a combined process is described as Example 4 in which the temperature control of the molding die during the injection molding and the step of parting wherein the second molding die 102 or the stamper 101 is moved relatively in the parting direction R are combined.

A basic structure used in this Example of the stamper and the molding die is the same as that of example 3. The heating device for heating those and the cooling device for heating those are built-in the metal block part 102a and the auxiliary metal die 101a.

The stamper 101 and the second molding die 102 and the control of temperature shown in FIG. 16A through FIG. 16C is the same as those of the foregoing approach shown in FIG. 8A though FIG. 8C except that the metal block part 102a and the auxiliary metal die 101a are provided. Therefore the detail for FIG. 16A through FIG. 16C is omitted.

Then, as shown in FIG. 16D, the second molding die 102 and the stamper 101 are parted from each other while moving in the moving direction (the parting direction R) of the molding apparatus. At this time, it is preferable that the molded dihedral corner reflector array optical element together with the second molding die 102 can be parted from the stamper 101.

Then, as shown in FIG. 16E, the molded dihedral corner reflector array optical element 66 is removed from the second molding die 102. Since the dihedral corner reflector array optical element has the flat face on the molding die side, such removing is easily done comparatively.

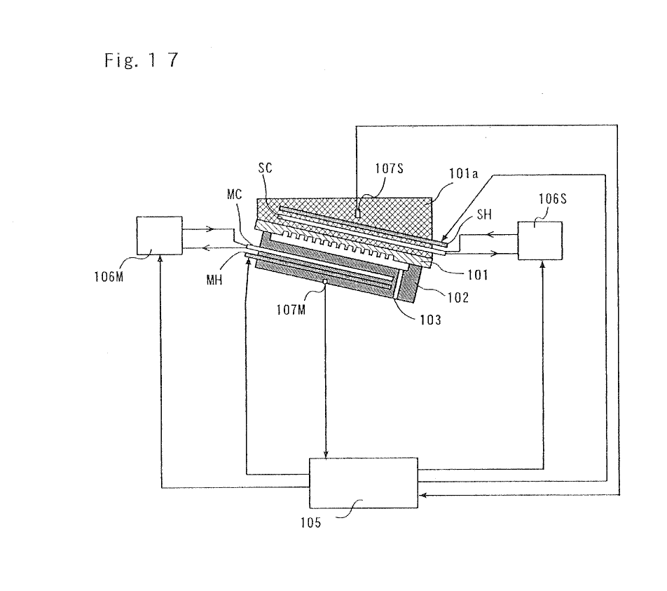

The control configuration of temperature for the stamper 101 and the second molding die 102 using the heating devices SH, MH and the cooling devices SC, MC shown in FIG. 17 is the same as those of the foregoing approach shown in FIG. 12 except the inclination thereof. Therefore the detail for FIG. 17 is omitted.

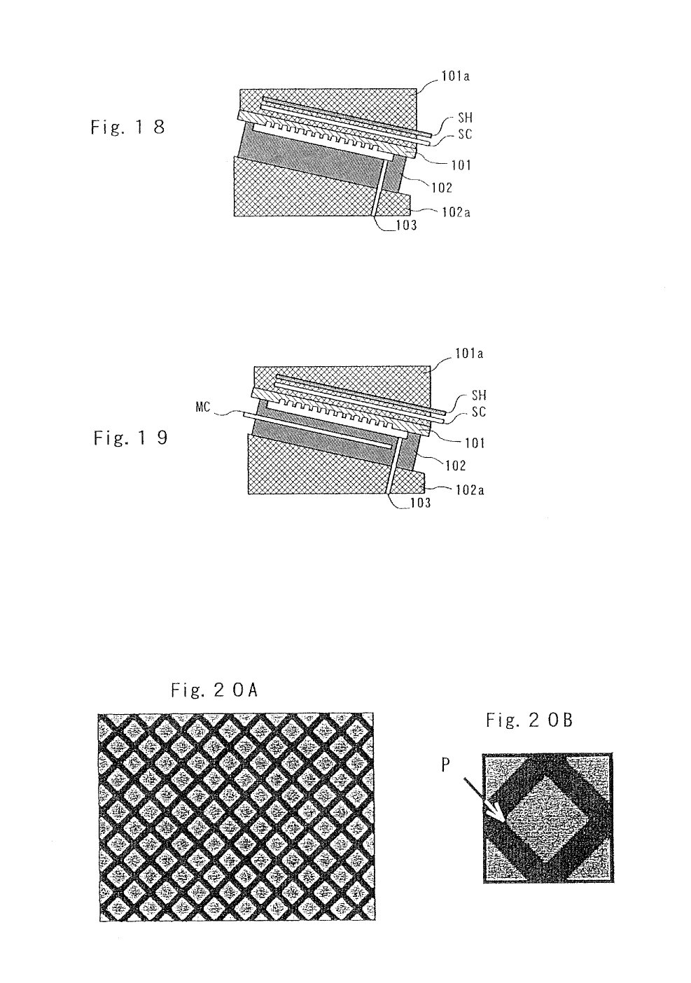

Although the heating device and the cooling device are provide on the sides of the stamper 101 and the second molding die 102 respectively in this above example, there are other examples such that the heating device SH and the cooling device SC are provided only in the auxiliary metal die 101a (see FIG. 18), and that the auxiliary metal die 101a accommodates the heating device SH and the cooling device SC at the same time, the cooling device MC is provided only in the second molding die 102 (see FIG. 19), or the like and the variation thereof is possible.

Further, in case that the stamper or the molding die is integrally fabricated together with a portion corresponding to the metal block, such integration can be formed to include necessary parts, the stampers or dies as one piece.

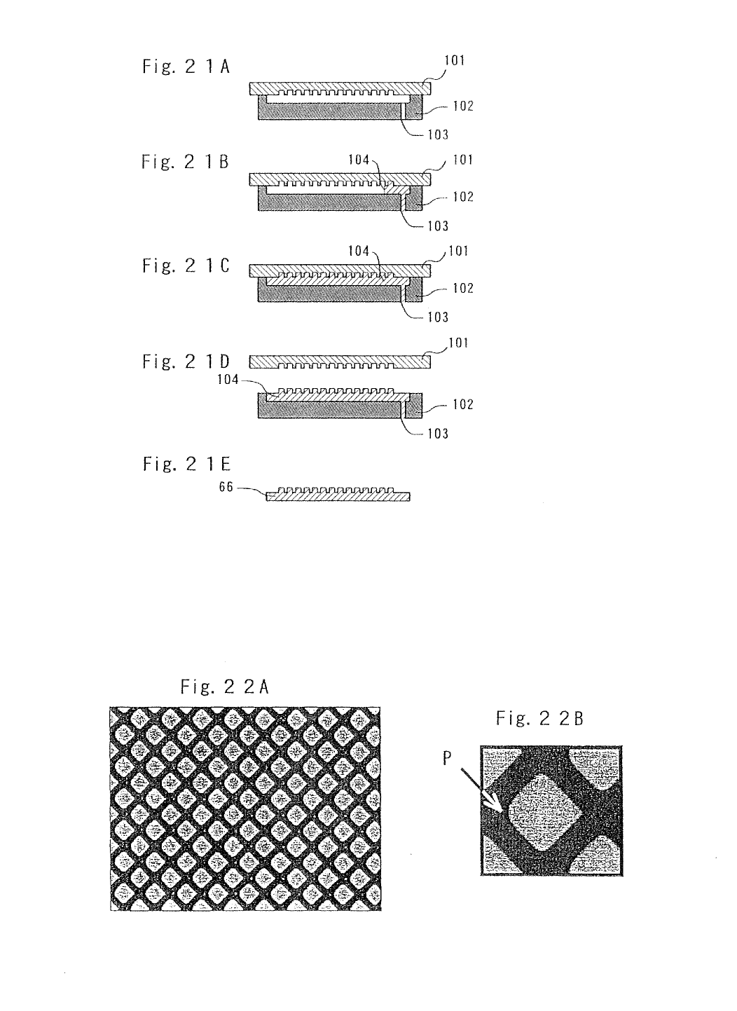

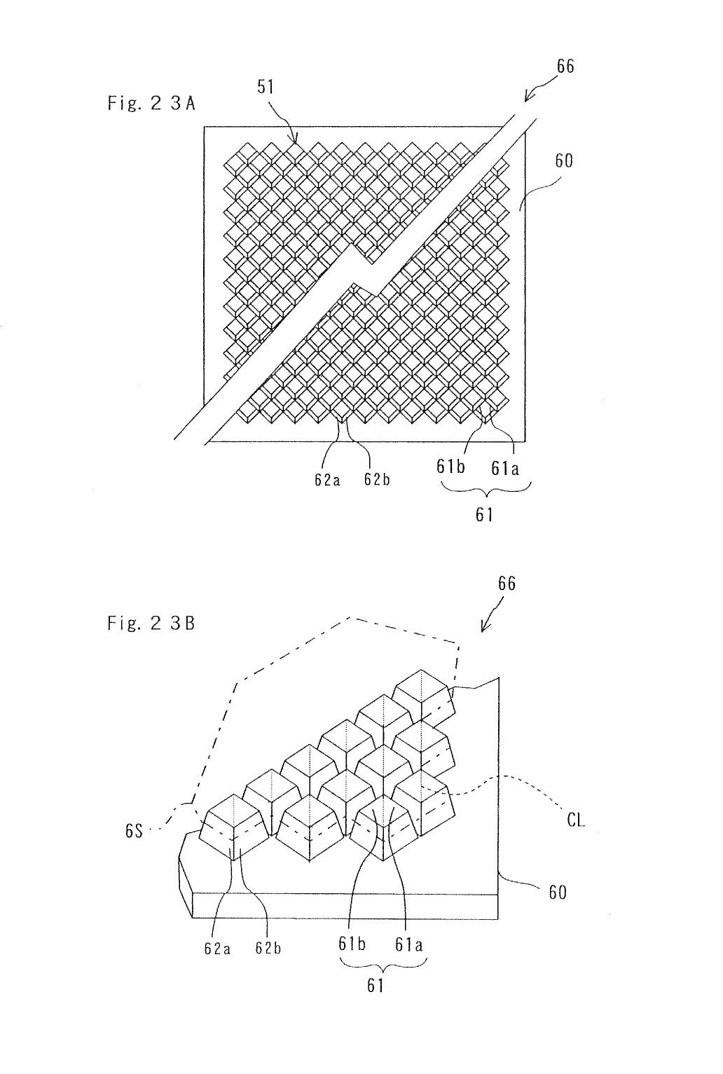

FIG. 20A and FIG. 20B show an observing result of enlarged plane images of dihedral corner reflector array optical elements fabricated according to examples FIG. 8, FIG. 13 and FIG. 16. FIG. 20B is aversion enlarged from FIG. 20A which is an enlarged photograph image of one prism body. As seen from FIG. 20B, a portion indicated by an arrow P, it is understood that a stamper shape is reproduced with a high transferability and a vertex of the prism body is sharply well-made. When the formation of real image was performed using such an example of the dihedral corner reflector array optical element, a beautiful real image was formed and observed.

A conventional dihedral corner reflector array optical element is described in such a process as below, which has been formed by a conventional injection molding process as a comparative one as shown in FIG. 21. Except that the dies are parted perpendicular to a flat surface of the substrate, FIG. 21 is the same as FIG. 13 basically.

As shown in FIG. 21A, the stamper 101 and the second molding die 102 are clamped to be contact directly with each other, and then theses are heated up to a temperature of higher than a softening temperature of a resin to be injected (for example 200° C. for use of acrylic resin)

As shown in FIG. 21B, a molten resin 104 is injected through a molding die gate portion 103 into a cavity between the stamper 101 and the second molding die 102 with a high pressure.

As shown in FIG. 21C, after injection of the resin 104, the stamper 101 and the second molding die 102 directly contacted with each other are cooled to a temperature lower than the softening temperature of the resin 104 (for example 80° C. for acrylic resin).

As shown in FIG. 21D, the second molding die 102 and the stamper 101 are parted from each other.

As shown in FIG. 21E, the molded optical element 6 is removed from the second molding die 102. Since the dihedral corner reflector array optical element has the flat face on the molding die side, such removing is easily done comparatively. When resin portions remaining in the gate portion are cut from the molded then the dihedral corner reflector array optical element completed.

FIG. 22A and FIG. 22B show an observing result of enlarged plane images of dihedral corner reflector array optical elements fabricated according to the comparative shown in FIG. 21. FIG. 22B is a version enlarged from FIG. 22A which is an enlarged photograph image of one prism body. As seen from FIG. 22A and FIG. 22B, the transferability is poor and the shape of the stamper 101 is reproduced insufficiently in the comparative element. Particularly, there is lack of sharpness on a vertex of the prism body (a portion indicated by an arrow P in FIG. 22B). When the formation of real image was performed using the comparative element of the dihedral corner reflector array optical element, only a very opaque image was observed.

According to the present invention, as shown in FIG. 23A, the dihedral corner reflector array optical element 66 is realized which comprises the transparent substrate 60 of a thin plate; and a plurality of transparent prism bodies 51 formed thereon, wherein each prism body 51 has a truncated pyramid shape (e.g., a square bottom plane, 50-200 μm per side) in the frontal view so that light passes through and between the base plane (bottom plane)and the top face, i.e., end plane of the prism body 51, wherein each prism body 51 has two orthogonal plane sides 61a and 61b used as the dihedral corner reflector 61. It may be configurable that some of the tapered surfaces that are not to form the dihedral corner reflectors 61 be subjected to no mirror finishing so that they will be made non-reflective or matte. It is also preferable that the dihedral corner reflectors 61 be arranged on regularly aligned lattice points so that the internal angles defined by the mirror surfaces 61a and 61b will be all positioned in the same direction on the substrate 60. Accordingly, a line of intersection CL of the orthogonal mirror surfaces 61a and 61b of each of the dihedral corner reflectors 61 is preferably orthogonal to the element surface 6S as shown in FIG. 23B. In the below, the direction of the internal angle defined by the mirror surfaces 61a and 61b is called the orientation (direction) of the dihedral corner reflector 61. In addition, metal reflective films may be formed on the outer plane sides (inner wall plane sides 61a and 61b) of the prism body 51 functioning as dihedral corner reflectors, so that the reflective efficiency the dihedral corner reflector is improved.

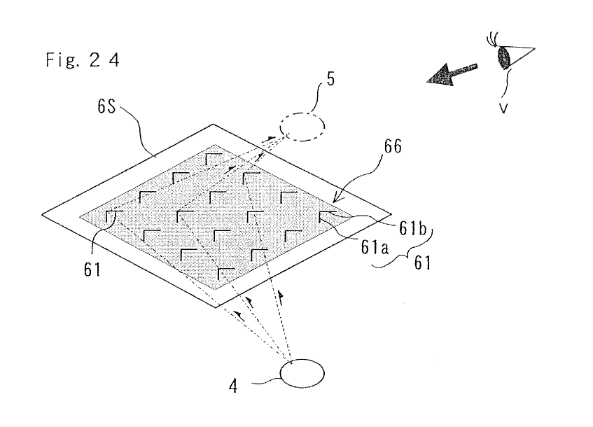

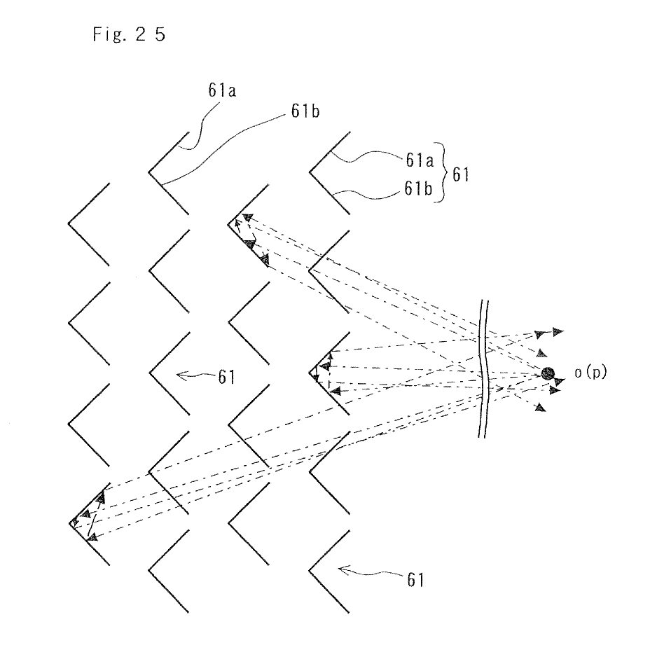

As is schematically shown in FIG. 24, a display device according to the present invention comprises: and an observed object 4 disposed by one surface side of the substrate, wherein the dihedral corner reflector array optical element forms a real image 5 (real specular image) of the object by the other surface side of the substrate. The dihedral corner reflector array optical element 66 is constructed of a large number of dihedral corner reflectors 61 each having two orthogonal mirror surfaces 61a and 61b, in which flat surface substantially orthogonal to the two mirror surfaces 61a and 61b of each of the dihedral corner reflectors 61 is defined as an element surface 6S. The real specular image 5 of the object 4 is formed at a position plane-symmetrical to the object 4 with respect to the element surface 6S. In the present embodiment, the dihedral corner reflectors 61 are considerably small (on the order of micrometers) compared to the entire size (on the order of centimeters) of the dihedral corner reflector array optical element 66. In FIG. 24, an aggregate of the dihedral corner reflectors 61 is shown in gray and a dihedral angle defined by the mirror surfaces are indicated by V shapes as showing an orientation of the interior corners thereof, so that the dihedral corner reflectors 61 are exaggeratedly shown in the figure.

In the dihedral corner reflector array optical element 66 of the invention, plain sides of the protruding prism body are formed to be perpendicular to the substrate (61a, 61b in FIG. 24) expect inclined plane sides of the feature of the invention.

In each of the dihedral corner reflectors 61 constituting the dihedral corner reflector array optical element 66, light rays entering the corresponding hole via the rear side (object-side space) are reflected by one mirror surface 61a (or 61b). The reflected light ray is further reflected by the other mirror surface 61b (or 61a), and is then caused to pass through the dihedral corner reflector 61 via the front side (viewer-side space) so that each dihedral corner reflector has a so-called twice reflection function. A path along which each light ray enters the dihedral corner reflector 61 and a path along which the light ray exits the dihedral corner reflector 61 are plane-symmetrical to each other with respect to the element surface 6S. Specifically, assuming that the element surface 6S is a surface passing the central portion of the height of each mirror surface and orthogonal to each mirror surface, the element surface 6S is a plane of symmetry with respect to which the position of the real image formed as a floating image, i.e., real specular image 5 of the object 4 is plane-symmetrical to the object 4.

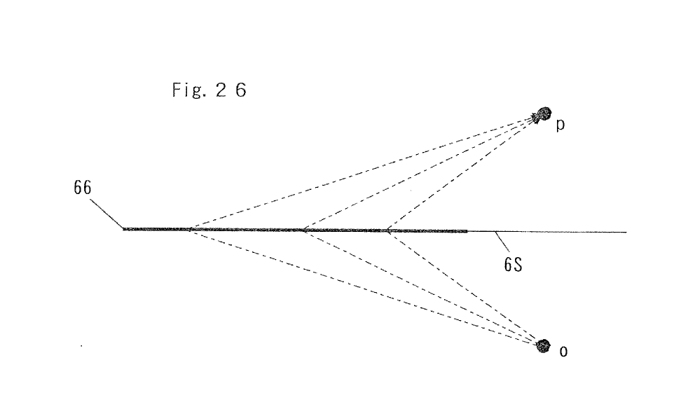

Briefly described next together with a path of each light ray emitted from a point light source (o) as an observed object is how an image is formed by the dihedral corner reflector array optical element 66. FIG. 25 is a schematic plan view of the dihedral corner reflector array optical element 66, and FIG. 26 is a schematic cross-section view of part of the dihedral corner reflector array optical element 66. In FIG. 25, the dihedral corner reflectors 61 and the mirror surfaces 61a, 61b are shown to be quite exaggerated in comparison to the entirety of the dihedral corner reflector array optical element 66. As is shown in FIGS. 25 and 26, when passing through the dihedral corner reflector array optical element 66, light rays emitted from the point light source (o) (indicated by one-dot arrowed chain lines traveling from the back toward the front on the drawing when viewed three-dimensionally in FIG. 25) are each reflected once by one mirror surface 61a (or 61b), and is reflected further by the other mirror surface 61b (or 61a) of each of the dihedral corner reflectors 61. Next, the reflected light rays pass through the element surface 6S, and then pass in dispersion a point that is plane-symmetrical to the point light source (o) with respect to the element surface 6S of the dihedral corner reflector array optical element 66. Incoming light rays and reflected light rays are shown to be parallel in FIG. 25. The reason therefor is as follows. In FIG. 25, the dihedral corner reflectors 61 are shown to be exaggeratedly large in comparison to the point light source (o). However, the actual size of the dihedral corner reflectors 61 is considerably small. Accordingly, incoming light rays and reflected light rays nearly overlap each other when the dihedral corner reflector array optical element 66 is viewed from above. (In FIG. 25, paths of light rays that first fall on both of the two mirror surfaces (61a, 61), namely, two paths, of each of the dihedral corner reflectors 61 are shown. In FIG. 26, only one light ray that first falls on either of the mirror surfaces is shown in order to avoid complication.) In summary, light rays converge to a position plane-symmetrical to the point light source (o) with respect to the element surface 6S, so that a real image is formed at a position (p) shown in FIGS. 25 and 26.

As described above, it is preferable to provide reflective films such as metal films on the orthogonal plane sides of the prism body functioning as dihedral corner reflectors. The inventors have found that the forming of reflective films may be omitted, and a product as resin-molded of the optical element, i.e., a dihedral corner reflector array optical element without any reflective film has performed the formation of real image with a sufficient light flex in practice because there is obtained a sufficient difference in refraction index between the resin and the air.

Since a product as resin-molded of the optical element, i.e., a dihedral corner reflector array optical element without any reflective film is usable, the invention therefore provides a low cost display device for allowing a viewer to see a real image (real specular image) of an observed object in air.

A described above, the above examples use prism bodies each having a truncated pyramid shape, but not limited thereto, any shape such as a sector shape, triangle shape may be employed as far as there are two orthogonal plane sides as the dihedral corner reflector. In this case the parting direction between the molding die and the stamper is a stray direction inclined with respect to a line bisecting the right angle (an angle of 45° to the reflector face) and the line of intersection. For example, it is set that an angle formed between a normal line of the substrate and the parting direction between the molding die and the stamper, is ½ of an angle formed between a normal line of the substrate and the line of intersection drawn in a cross section of the prism body taken off perpendicular to substrate plane.

It is understood that the foregoing description and accompanying drawings set forth the preferred embodiments of the present invention at the present time. Various modifications, additions and alternative designs will, of course, become apparent to those skilled in the art in light of the foregoing teachings without departing from the spirit and scope of the disclosed invention. Thus, it should be appreciated that the present invention is not limited to the disclosed embodiments but may be practiced within the full scope of the appended claims.

This application is based upon and claims the benefit of priority from the prior Japanese Patent Applications Nos. 2010-191744, filed on Aug. 30, 2010, and 2010-264820, filed on Nov. 29, 2010, the entire contents of which are incorporated herein by reference.

What is claimed is:

1. A method for fabricating a dihedral corner reflector array optical element which comprises a substrate and a plurality of prism bodies arranged regularly on and each protruding from a base plane of the substrate wherein the prism bodies and the substrate are integrally formed of a transparent material, each prism body including two orthogonal plane sides which are perpendicular to each other to be a dihedral corner reflector, wherein when an observed object exists by one surface side of the substrate then the dihedral corner reflector array optical element forms a real image of the object by the other surface side of the substrate, the method comprising:
clamping a first molding die and a second molding die to define a cavity therebetween, where the first molding die has a reversal shape of the prism bodies and the second molding die has a flat face, where each prism body has a frustum shape having an end plane whose area is smaller than that of the base plane side of the substrate, where each prism body is composed of a rectangular parallelepiped portion including the orthogonal plane sides and a taper portion integrated therewith having sides being non-parallel to the orthogonal plane sides;
forming a dihedral corner reflector array optical element made from molten resin in the cavity; and
parting the dihedral corner reflector array optical element from the molding dies after cooled.

2. The method according to claim 1, wherein the forming step includes injecting the molten resin into the cavity while keeping at least one of the first and second molding dies at a temperature of higher than a predetermined temperature; and cooling the molding die at another temperature less than the predetermined temperature after the cavity filled.

3. The method according to claim 2, wherein the predetermined temperature is a softening temperature of the resin used in the forming step.

4. The method according to claim 1, wherein, in the parting step, the molding dies are relatively moved in a parting direction that the first molding die leaves the orthogonal plane sides before anything else to part the dihedral corner reflector array optical element after cooled.

5. The method according to claim 4, wherein the parting direction is set within a pyramid-like space extent surrounded by two orthogonal side virtual planes and two taper virtual planes and having a vertex of the end plane and the orthogonal plane sides of the prism body, wherein the orthogonal side virtual planes are extended parallel to the orthogonal plane sides respectively and the taper virtual planes are parallel to the sides being non-parallel to the orthogonal plane sides respectively, wherein the parting direction is a stray direction extended from the vertex in the end plane of the prism body and inclined away from a line of intersection of the orthogonal plane sides.

6. The method according to claim 1 further comprising a step of providing metal reflective films on the orthogonal plane sides respectively.

7. The method according to claim 1, wherein a taper angle of the sides being non-parallel to the dihedral corner reflector is an angle within range of 5° or more and 25° or less with respect to a line of intersection of the orthogonal plane sides.

8. A dihedral corner reflector array optical element, fabricated by the method according to claim 1, comprising:
a substrate; and
a plurality of prism bodies arranged regularly on and each protruding from a base plane of the substrate,
wherein the prism bodies and the substrate are integrally formed of a transparent material, each prism body including two orthogonal plane sides which are perpendicular to each other to be a dihedral corner reflector, wherein when an observed object exists by one surface side of the substrate then the dihedral corner reflector array optical element forms a real image of the object by the other surface side of the substrate, wherein the prism bodies and the second molding die has a flat face, where each prism body has a frustum shape having an end plane whose area is smaller than that of the base plane side of the substrate, where each prism body is composed of a rectangular parallelepiped portion including the orthogonal plane sides and a taper portion integrated therewith having sides being non-parallel to the orthogonal plane sides.

9. A display device comprising: the dihedral corner reflector array optical element according to claim 1; and an observed object disposed by one surface side of the substrate, wherein the dihedral corner reflector array optical element forms a real image of the object by the other surface side of the substrate.
